(19) United States
(12) Patent Application Publication
(10) Pub. No.: US 2010/0030670 A1
(43) Pub. Date: Feb. 4, 2010

(54) METHOD OF MONITORING DIFFERENT DEBIT CARD TRANSACTIONS ASSOCIATED WITH A SINGLE FUNDING SOURCE

(75) Inventor: Thomas F. Misson, JR., New York, NY (US)

Correspondence Address: HOFFMANN & BARON, LLP, 6900 JERICHO TURNPIKE, SYOSSET, NY, 11791, US

(73) Assignee: MasterCard International, Inc., Purchase, NY (US)

(21) Appl. No.: 12/512,417

(22) Filed: Jul. 30, 2009

Related U.S. Application Data
(60) Provisional application No. 61/086,087, filed on Aug. 4, 2008.

(51) Int. Cl. G06Q 40/00; G07F 19/00; G06Q 10/00

(52) U.S. Cl. 705/30; 235/379; 235/380

(57) ABSTRACT

The invention herein relates to a method of monitoring different debit card transactions associated with a single funding source. In particular, the method includes associating first and second debit cards with a single funding source, the first and second debit cards having different identification codes, different levels of transaction data and having different characteristics associated therewith. Further, the method includes reviewing debit card transactions settled from the funding source. Debit card transactions associated with the first and second debit cards are identified. Separate records are maintained for the debit card transactions identified with the first debit card and for debit card transactions identified with the second debit card. Advantageously, the method of the subject invention permits personal and business expenses settled from a single funding source to be identified and for records to be maintained thereof.

### CROSS-REFERENCE TO RELATED APPLICATION

This application claims priority to U.S. Provisional Patent Application No. 61/086,087 filed on Aug. 4, 2008, the contents of which is incorporated herein by reference in its entirety.

### FIELD OF THE INVENTION

This invention relates to debit card transactions and, more particularly, to the extent of debit card transaction data provided and the method for accounting for such debit card transactions.

### DESCRIPTIONS OF THE PRIOR ART

Debit card transactions are well known in the prior art. Due to the convenience of use, some individuals have a preference to use debit card transactions rather than check writing to pay expenses.

Many small-business owners have a tendency to conduct all of their financial dealings from a single bank account. As such, personal and business-related expenses are co-mingled and difficult, if not impossible, to distinguish. In addition, many individuals as part of their normal profession are required to pay for certain expenses which are later reimbursed. For example, professional fees, travel expenses, entertainment of clients, and so forth are common professional-related expenses which are often paid out-of-pocket and later reimbursed. These expenses likewise are normally taken from personal bank accounts, which may be later difficult to identify.

### SUMMARY OF THE INVENTION

The invention herein relates to a method of monitoring different debit card transactions associated with a single funding source. In particular, the method includes associating first and second debit cards with a single funding source, the first and second debit cards having different identification codes and having different characteristics associated therewith. Further, the method includes reviewing debit card transactions settled from the funding source. Debit card transactions associated with the first and second debit cards are identified. Separate records are maintained for the debit card transactions identified with the first debit card and for debit card transactions identified with the second debit card. Advantageously, the method of the subject invention permits personal and business expenses settled from a single funding source to be identified and for records to be maintained thereof.

These and other features of the subject invention will be better understood through a study of the following detailed description and accompanying drawings.

### BRIEF DESCRIPTION OF THE DRAWINGS

FIG. 1 is a schematic of the subject invention.

FIG. 2 is a statement useable with the subject invention.

FIG. 3 is a statement useable with the subject invention showing enhanced data transactions.

FIGS. 4-8 show examples of details of transaction data fields provided by enhanced data transactions.

### DETAILED DESCRIPTION OF THE INVENTION

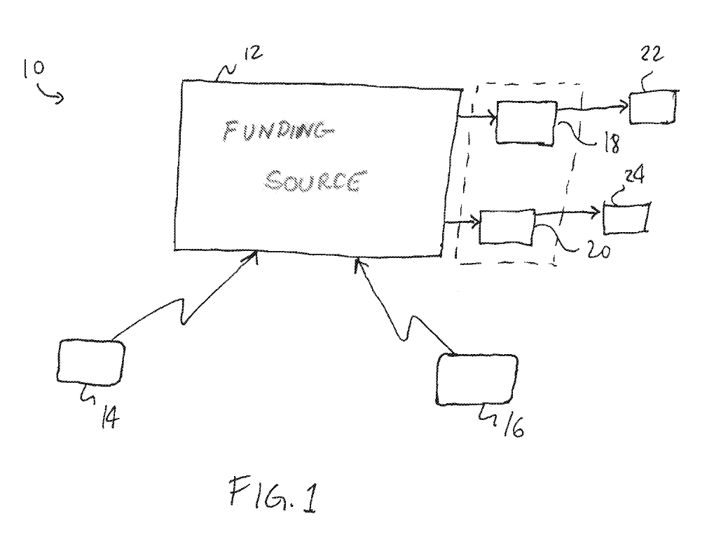

With reference to FIG. 1, a system 10 is shown schematically for conducting the invention herein. In particular, the system 10 is configured to allow monitoring of different debit card transactions associated with a single funding source 12. The funding source 12 may be of any type known which permits debit card transactions therefrom. Preferably, the funding source 12 is a bank account, more preferably, a checking-account, and more preferably, a personal checking account.

First and second debit cards 14, 16, respectively, are associated with the funding source 12. As will be appreciated by those skilled in the art, additional debit cards may be utilized in accordance with the subject invention. A “debit card” may be a debit instrument in any known format, including being a plastic card or an electronic device. In known fashion, the first and second debit cards 14, 16 are each associated with an identification code, the identification codes for the first and second debit cards 14, 16 being different. The identification codes may be made different for the first and second debit cards 14, 16 by providing different ISO Bank Identification Number (BIN) numbers for each card. In this manner, the institution issuing the debit cards 14, 16 may associate all of the target debit cards 14, 16 with the single funding source 12.

The first and second debit cards 14, 16 may be used in commerce to conduct debit card transactions. Standard processes for authentication and settlement may be utilized, including, but not limited to, Automated Clearing House (ACH) payments.

During use, all of the debit card transactions settled from the funding source 12 are reviewed. Debit card transactions associated with the first debit card 14 are identified, and debit card transactions associated with the second debit card 16 are also identified. The identification codes of the first and second debit cards 14, 16 may provide the ability to identify transactions associated with each of the debit cards 14, 16. The reviewing of the debit card transactions may be conducted through any known configuration which permits sufficient access to the debit card transactions to properly segregate the transactions.

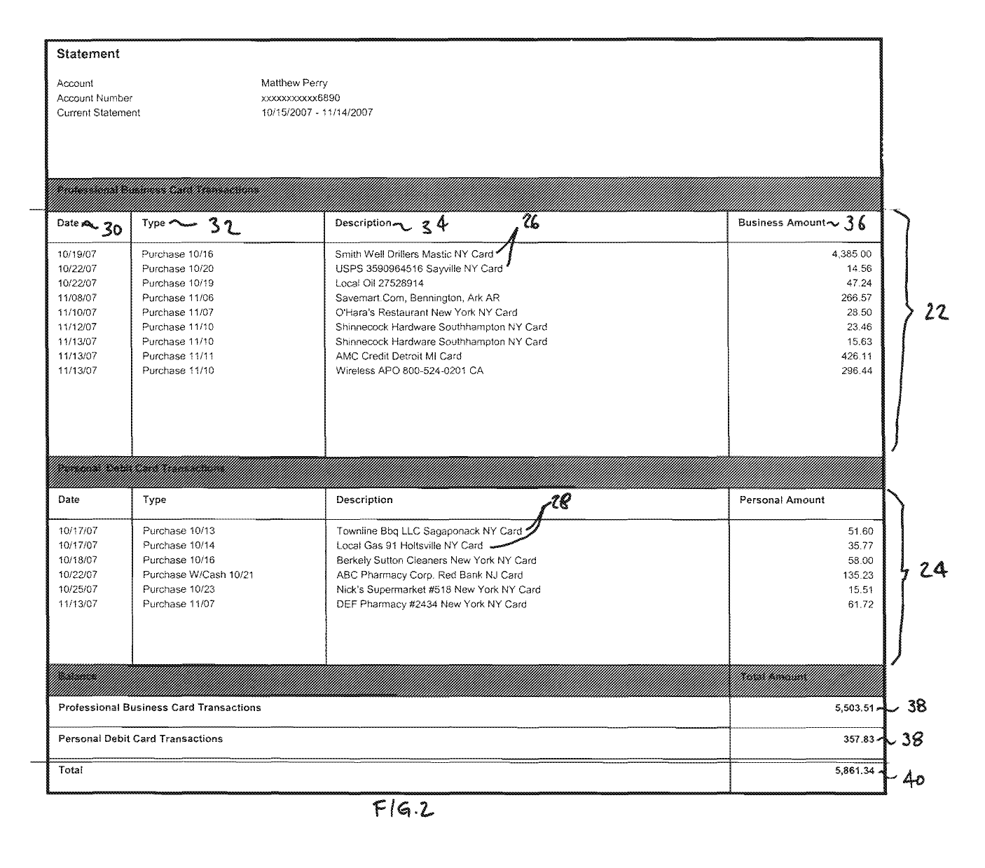

Separate records 18, 20, respectively, are generated and maintained for the debit card transactions identified for the first debit card 14 and for the debit card transactions identified for the second debit card 16. The first and second debit card records 18, 20 can be maintained in any known format, including in electronic and/or paper format. In addition, the records 18, 20 may be maintained at a common location, but kept in separate identifiable records (e.g., separate files in a common CPU and/or over a network). Based on the records 18, 20, separate statements or separate sections of one statement 22, 24 for the first and second debit cards 14, 16, respectively, may be generated. The separate statements 22, 24 may be provided in any form including in electronic and/or paper format. The statements 22, 24 may be presented in any format which separates the two sets of data from the records 18, 20. The statements 22, 24 may be combined with the individual sets of data being delineated. For example, with reference to FIG. 2, the statements 22, 24 may be presented as a single document (in electronic or paper format) with transactions 26 associated with the first debit card 14 being delineated from transactions 28 associated with the second debit card 16. As will be appreciated by those skilled in the art, various graphical representations may be utilized to depict and delineate the transactions 26, 28. The statements 22, 24 may include various reporting data, such as dates of transactions 30, type (e.g., purchase, cash withdrawal) 32, description (e.g., vendor, location) 34, and amount 36. Subtotals 38 and totals 40 of the transaction amounts may also be provided.

With the subject invention, transactions associated with each of the first and second debit cards 14, 16 may be separately identified by a user. Advantageously, personal and business expenses in this manner may be separated. For example, with the first debit card 14 being used solely for business expenses and the second debit card 16 being used solely for personal expenses, the resulting generated statements shall provide summaries of business and personal transactions.

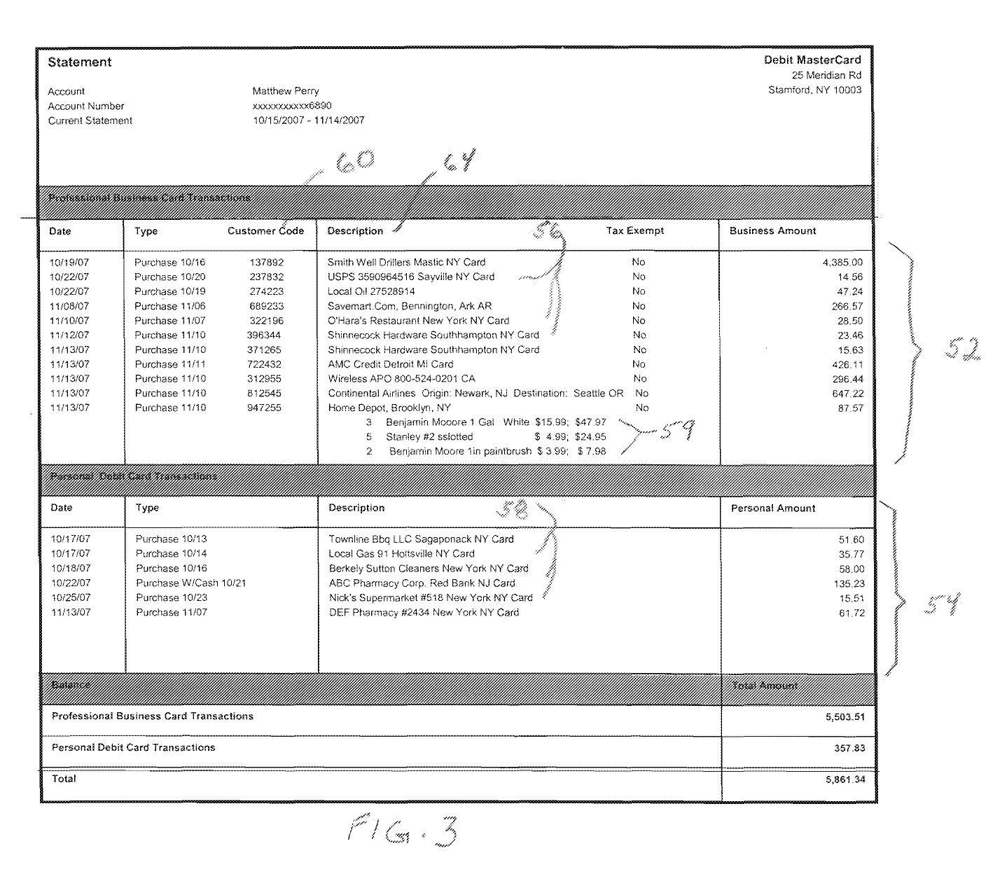

In addition, the first and second debit cards 14, 16 are preferably provided with different characteristics. For example, the first debit card 14, may be a business debit card and have associated therewith one or more characteristics which are not associated with the second debit card 16, which may be a personal expense debit card. The characteristics that make a business debit card different from a personal debit card include the type of information delivered as part of each transaction. In addition and more specifically, business debit transactions processed through a network may have additional transaction data collectively known as “enhanced data”. Enhanced data is only provided on business debit transactions and is provided to the business debit cardholder at the discretion of the issuing bank. Examples of such enhanced data elements are shown in FIG. 3.

With reference to the examples set forth in FIG. 3, the statements 52, 54 may be represented as a single document (an electronic or paper format) with transactions 56 associated with the first debit card 14 being delineated from transactions 58 associated with the second debit card 16. With respect to enhanced data transactions for example, the additional or different information may be provided with respect to debit card 14, which may be indicated as relating to the business debit card. Such additional information, as shown in FIG. 3 by way of example, may include customer codes 60 associated with each transaction so as to provide more specific and enumerated information 59 with regard to individual purchases. For example, with respect to a listed purchase 64, inventory of the purchase may be detailed in the business debit card transaction. The information provided by the enhanced data field will be of more assistance in tracking business transactions. FIG. 3 shows only by way of example the information which may be additionally provided with respect to enhanced data transactions.

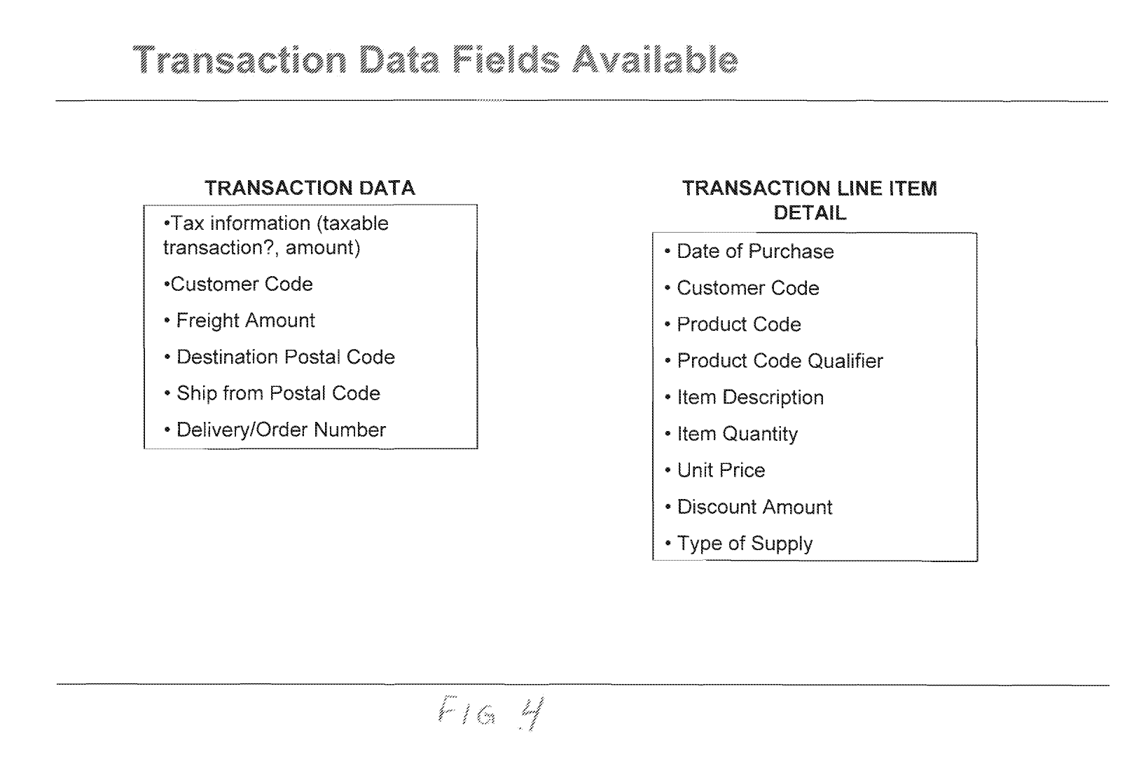

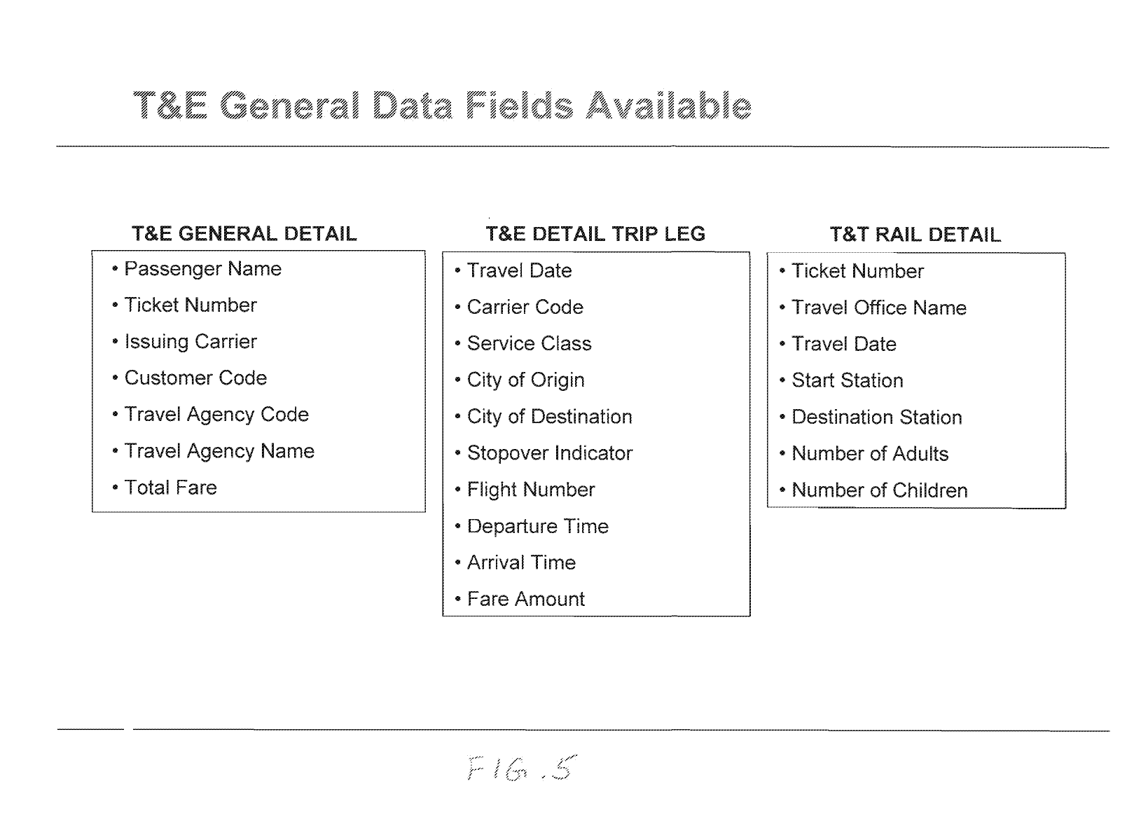

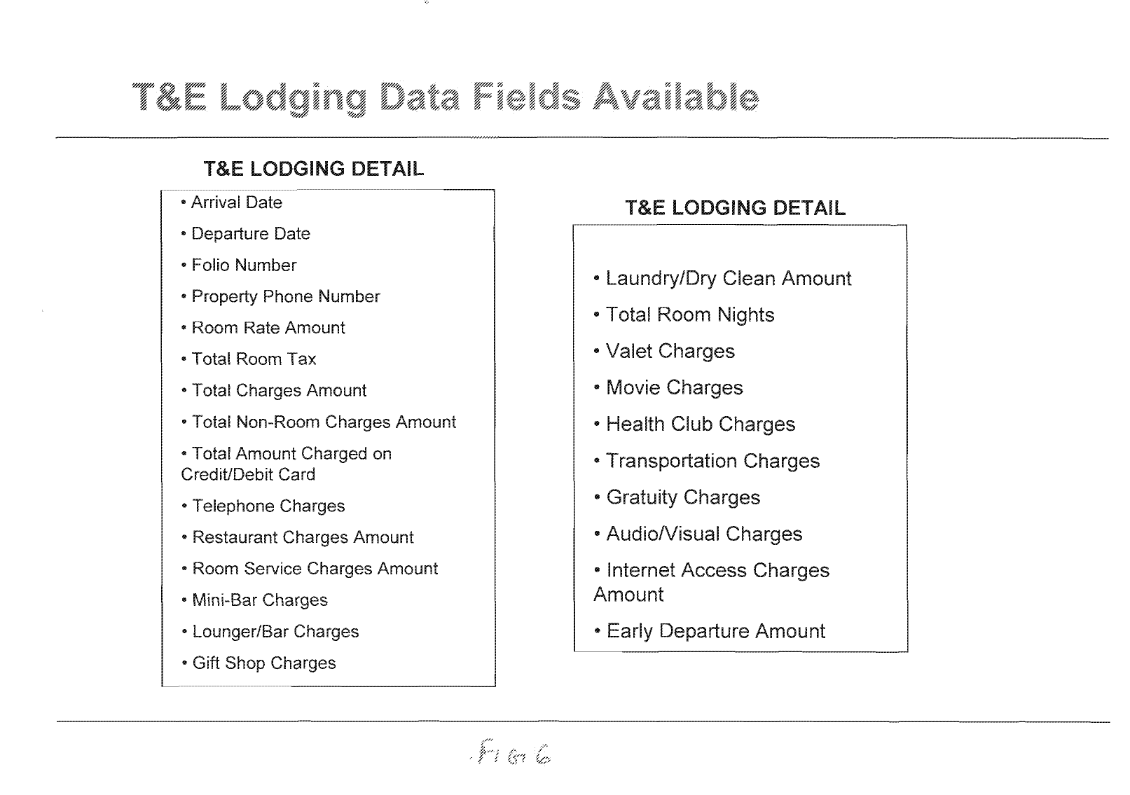

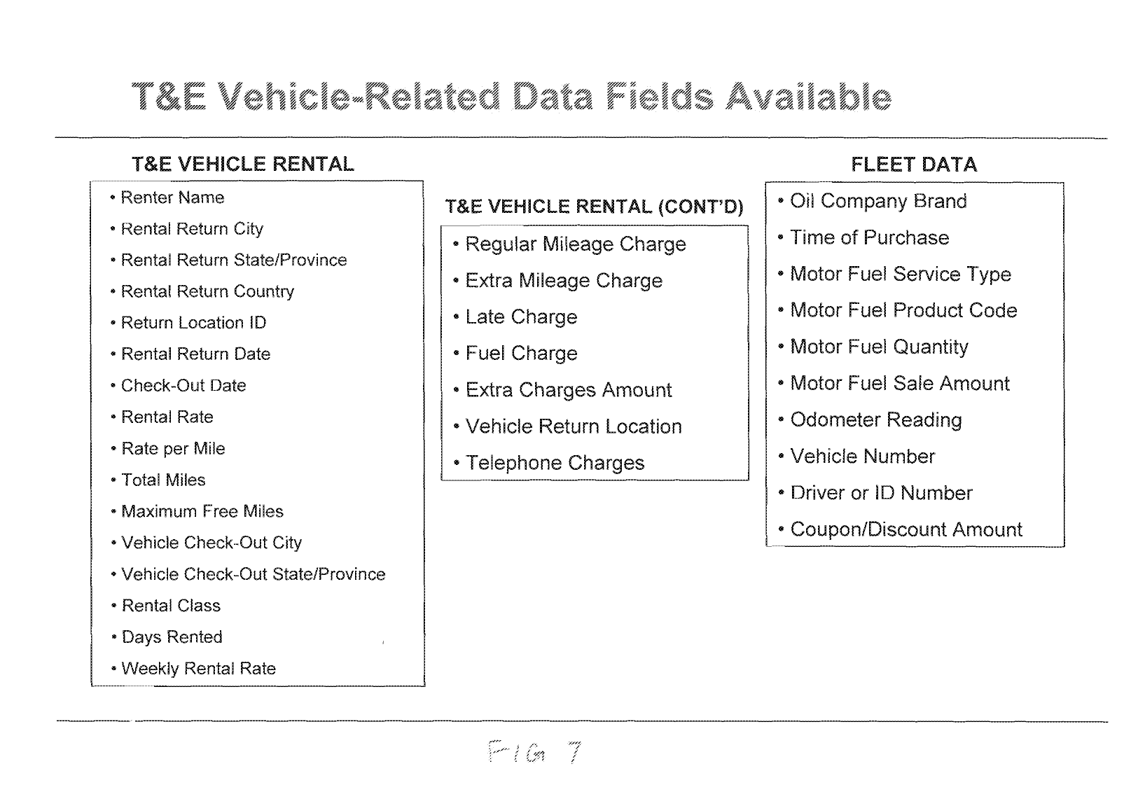

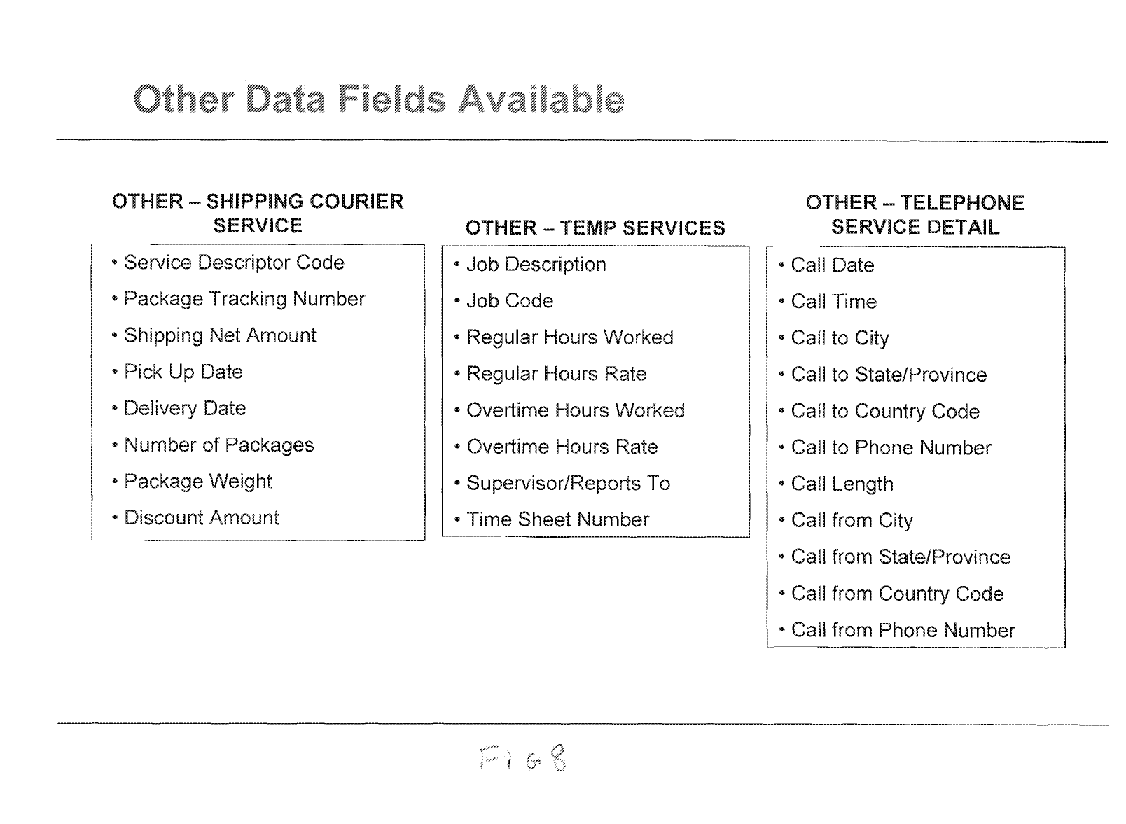

Referring now to FIG. 4, a non-inclusive listing of transaction data and transaction line item details may be provided with respect to enhanced data of the present invention is shown. In FIG. 5, the enhanced data with respect to general data fields, specifically with respect to transportation and travel, is shown. Turning to FIG. 6, the enhanced data with respect to lodging data is shown. FIG. 7 shows enhanced data fields available with respect to vehicle rentals. Similarly enhanced data with respect to other miscellaneous data fields is also shown in FIG. 8. While FIGS. 4-8 show examples of enhanced data in various fields, it should be appreciated that the enhanced data features of the present invention are not limited thereto.

Additional characteristics that separate business debit from personal debit may include business related card benefits such as warranty for select transactions; availability of roadside assistance; insurance for select transactions; theft protection (e.g., employee theft protection); and/or availability of a rewards program. Certain characteristics may include certain business centric characteristics including enhanced data, tools to help a business debit cardholder more effectively manage their business, varies card warranty benefits, and other business type benefits. Characteristics may be also associated with the second debit card 16 which may be the same or different from the first debit card 14. The provision of various characteristics enhances the ability to promote the system 10.

Preferably, the first debit card 14 is a business debit card, and the second debit card 16 is a personal debit card. Characteristics may he provided for each of the debit cards 14, 16 tailored to its respective type. As used herein, a “business debit card” is a debit instrument for which a user fee may be paid by a user to the issuer of the debit instrument and a number of characteristics are associated therewith. For example, with the first debit card 14 being a business debit card, the first debit card 14 may have associated therewith: enhanced data, warranty for select transactions; availability of roadside assistance; insurance for select transactions; theft protection (e.g., employee theft protection, cardholder zero liability); and/or availability of a rewards program, such as MasterCard Easy Savings automatic rebate program that does not require coupon codes. Other characteristics, such as employee theft protection and automatic rental protection, may be with the first debit card 14, as well as other business-related debit instrument characteristics. The second debit card 16 may be tailored to personal usage, having a different set of associated characteristics from the first debit card 14. Preferably, the first debit card 14 will have more characteristics associated therewith than the second debit card 16. The second debit card 16 may have one or more of the characteristics of the first debit card 14, but less in quantity and will not contain enhanced. In addition, the second debit card 16 may have some or all of the same characteristics of the first debit card 14, with one or more of the characteristics being provided in different form. Preferably, the first debit card 14 will have associated therewith a stronger version of one or more characteristic(s) common with the second debit card 16. For example, both the first and second debit cards 14, 16 may provide warranties on purchases, with the first debit card 14 providing a program of greater coverage (e.g., higher price limits; greater scope; etc.).

What is claimed is:

1. A method of monitoring different debit card transactions associated with a single funding source, said method comprising:
associating first and second debit cards with a single funding source, said first and second debit cards having different identification codes, said first and second debit cards having different characteristics associated therewith;
reviewing debit card transactions settled from said funding source;
identifying said reviewed debit card transactions associated with said first debit card;
identifying said reviewed debit card transactions associated with said second debit card; and,
maintaining separate records for said debit card transactions identified with said first debit card and for said debit card transactions identified with said second debit card.

2. A method as in claim 1, wherein said first debit card is a business debit card.

3. A method as in claim 1, wherein said second debit card is a personal debit card.

4. A method as in claim 1, wherein said first debit card has associated therewith the characteristics of business benefits for select transactions.

5. A method as in claim 1, wherein said first debit card has associated therewith the characteristics of availability of roadside assistance.

6. A method as in claim 1, wherein said first debit card has associated therewith the characteristics of insurance for select transactions.

7. A method as in claim 1, wherein said first debit card has associated therewith the characteristics of availability of a rewards program such as a rebate reward program.

8. A method as in claim 1, further comprising providing separate statements for said debit card transactions identified with said first debit card and for said debit card transactions identified with said second debit card.

9. A method as in claim 8, wherein said statements are in electronic format.

10. A method as in claim 8, wherein said statements are in paper format.

11. A method of claim 1 further including the step of identifying a degree of additional transaction information associated with said first and/or second debit cards.

12. A method of claim 11 wherein said additional transaction information includes enhanced data transactions.
